(19) United States
(12) Patent Application Publication
(10) Pub. No.: US 2026/0163192 A1
(43) Pub. Date: Jun. 11, 2026

(54) INTER-MODULE BUSBAR WITH EXTINGUISHING LIQUID

(71) Applicant: LG ENERGY SOLUTION, LTD., Seoul (KR)

(72) Inventors: Sung Tack HWANG, Daejeon (KR); Won Tae LEE, Daejeon (KR); Kyu Hwan OH, Daejeon (KR)

(73) Assignee: LG ENERGY SOLUTION, LTD., Seoul (KR)

(21) Appl. No.: 18/706,687

(22) PCT Filed: Aug. 10, 2023
(86) PCT No.: PCT/KR2023/011798

§ 371 Date: May 1, 2024

(30) Foreign Application Priority Data
Aug. 16, 2022 (KR) 10-2022-0101747

(51) Int. Cl. H01M 50/503; A62C 3/16; H01M 50/673

(52) U.S. Cl. CPC H01M 50/503; A62C 3/16; H01M 50/673

(57) ABSTRACT

An inter-module busbar configured to connect battery modules to each other, and more particularly to an inter-module busbar, includes a metal bar made of an electrically conductive metal material and an insulator located on a part of the metal bar excluding opposite ends thereof. An extinguishing liquid is included in the insulator.

### TECHNICAL FIELD

This application claims the benefit of priority to Korean Patent Application No. 2022-0101747 filed on Aug. 16, 2022, the disclosure of which is incorporated herein by reference in its entirety.

The present invention relates to an inter-module busbar configured to connect battery modules to each other, and more particularly to an inter-module busbar having a structure of an insulator configured to protect a metal bar made of an electrically conductive metal material from the outside and a structure including an extinguishing liquid capable of extinguishing fire in the event of the fire.

### BACKGROUND ART

With recent development of alternative energies due to air pollution and energy depletion caused as the result of use of fossil fuels, demand for secondary batteries capable of storing electrical energy that is produced has increased. Secondary batteries, which are capable of being charged and discharged, are intimately used in daily life. For example, secondary batteries are used in mobile devices, electric vehicles, and hybrid electric vehicles.

Required capacities of secondary batteries used as energy sources of various kinds of electronic devices inevitably used in modern society have been increased due to an increase in usage of mobile devices, increasing complexity of the mobile devices, and development of electric vehicles. In order to satisfy demand of users, a plurality of battery cells is disposed in a small-sized device, whereas a battery module including a plurality of battery cells electrically connected to each other or a battery pack including a plurality of battery modules is used in a vehicle, etc.

Meanwhile, a busbar is widely used as a means for electrical connection between the battery modules, and is useful as a large current conduction means since the busbar is capable of allowing large current to stably flow therethrough even with a relatively small thickness compared to a cable.

In general, the busbar may be provided in the form of a metal bar, such as copper or aluminum, which exhibits excellent electrical conductivity, and the remaining part of the metal bar, excluding opposite ends connected to terminals, is covered with a tube or an injection-molded product for safety.

When fire breaks out in the battery pack, however, the tube or the injection-molded product may be burned away, whereby the metal bar may be exposed to the outside and may come into contact with a surrounding metal object, and therefore short circuit may occur.

In addition, there is no way to actively respond to flames using only a heat-resistant busbar that is resistant to fire.

In order to solve this problem, the following document (patent document) discloses a bandage means for preventing contact between a metal bar and a surrounding metal object through the provision of an insulating tube 20 configured to enclose an annular or band-shaped metal wire obtained by coating the remaining part of the metal bar 10, excluding opposite ends thereof, with a material having insulation and fire-resistant properties and a bandage member 30A, as shown in FIG. 1. However, only a structure to prevent electrical short circuit in the event of fire is disposed, and fundamental extinguishing means capable of extinguishing fire is neither disclosed nor implied.

### Prior Art Document

Korean Patent Application Publication No. 2021-0141095

### DISCLOSURE

### Technical Problem

The present invention has been made in view of the above problems, and it is an object of the present invention to provide an inter-module busbar having an extinguishing liquid provided in an insulator configured to surround a metal bar, wherein the extinguishing liquid leaks to directly extinguish flames in the event of fire.

### Technical Solution

An inter-module busbar according to the present invention to accomplish the above object includes a metal bar made of an electrically conductive metal material and at least one insulator located on a part of the metal bar excluding opposite ends of the metal bar, wherein an extinguishing liquid is included in the at least one insulator.

Also, in the inter-module busbar according to the present invention, the at least one insulator may be provided with a metal bar insertion hole, and the at least one insulator may be fitted onto the metal bar in a longitudinal direction thereof in one or more.

Also, in the inter-module busbar according to the present invention, the at least one insulator may be a plurality of insulators fitted on the metal bar and fixed to each other by an adhesive.

Also, in the inter-module busbar according to the present invention, the at least one insulator may include an inner insulation portion configured to surround the metal bar and an outer insulation portion configured to enclose an outer surface of the inner insulation portion excluding a side surface of the inner insulation portion, and the inner insulation portion may be provided with a space having the extinguishing liquid.

Also, in the inter-module busbar according to the present invention, the space may be formed between a first insulation layer in contact with the metal bar and a second insulation layer in contact with the outer insulation portion.

Also, in the inter-module busbar according to the present invention, the space may surround an entirety of the metal bar.

Also, in the inter-module busbar according to the present invention, the inner insulation portion may further include a first injection hole configured to allow the extinguishing liquid to be injected therethrough and a sealing cap configured to seal the first injection hole.

Also, in the inter-module busbar according to the present invention, the inner insulation portion may be provided with a first injection hole configured to allow the extinguishing liquid to be injected therethrough, the outer insulation portion may further include a second injection hole configured to communicate with the first injection hole, and the inter-module busbar may further include a sealing cap configured to seal the first injection hole and the second injection hole.

Also, in the inter-module busbar according to the present invention, the first insulation layer may be thicker than the second insulation layer.

Also, in the inter-module busbar according to the present invention, the at least one insulator may have an inner insulation portion configured to surround the metal bar; and an outer insulation portion configured to enclose an outer surface of the inner insulation portion including the side surface of the inner insulation portion and the inner insulation portion may be provided with a space having the extinguishing liquid.

Also, in the inter-module busbar according to the present invention, the inner insulation portion may be made of an expandable heat-resistant silicone material.

Also, in the inter-module busbar according to the present invention, the outer insulation portion may be made of a heat-resistant silicone material configured to be ceramized by heat.

Also, in the inter-module busbar according to the present invention, the extinguishing liquid may be an insulative material.

### Advantageous Effects

As is apparent from the above description, an inter-module busbar according to the present invention has an advantage in that an extinguishing liquid is included in the busbar, and the extinguishing liquid leaks in the event of fire, whereby it is possible to early extinguish the fire.

In addition, the inter-module busbar according to the present invention has a merit in that the insulator configured to protect the busbar from external impact or to prevent electrical contact of the busbar is manufactured in block units such that insulator can be fitted onto a metal bar so as to cover the entire length of the metal bar, whereby it is possible to reduce the manufacturing cost of the busbar and to simplify the manufacturing process.

Furthermore, in the inter-module busbar according to the present invention, different extinguishing liquids may be injected into the busbar depending on the cause and type of fire, whereby it is possible to effectively deal with various fire causes and environments.

### DESCRIPTION OF DRAWINGS

FIG. 1 is a sectional view of a conventional inter-module busbar.

FIG. 2 is an exploded perspective view of an inter-module busbar according to a first preferred embodiment of the present invention.

FIG. 3 is an assembled perspective view of FIG. 2.

FIG. 4 is a perspective view of the inter-module busbar according to the first preferred embodiment of the present invention.

FIG. 5 is a vertical sectional view of an insulator according to a first preferred embodiment of the present invention, taken along line J-J.

FIG. 6 is a vertical sectional view of the insulator according to the first preferred embodiment of the present invention, taken along line K-K.

FIG. 7 is a perspective view of an inter-module busbar according to a second preferred embodiment of the present invention.

FIG. 8 is a vertical sectional view of an insulator according to a second preferred embodiment of the present invention, taken along line K-K.

FIG. 9 is a vertical sectional view of an insulator according to a third preferred embodiment of the present invention, taken along line K-K.

FIG. 10 is a vertical sectional view of an insulator according to a fourth preferred embodiment of the present invention, taken along line K-K.

FIG. 11 is a sectional view showing deformation of an inter-module busbar according to a preferred embodiment of the present invention due to fire under the inter-module busbar.

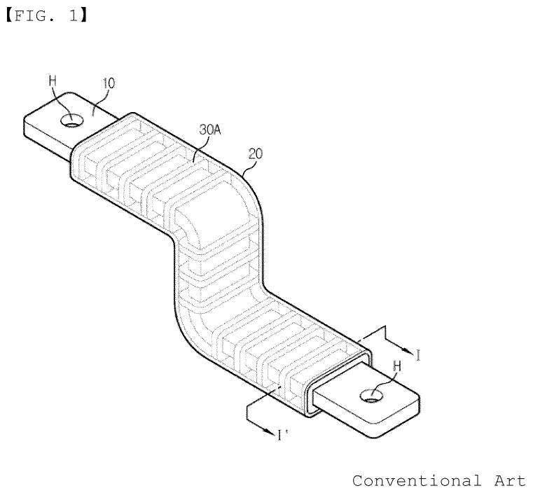

### BEST MODEL

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is the to be connected to another part in the entire specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, an inter-module busbar according to the present invention will be described in detail with reference to the accompanying drawings.

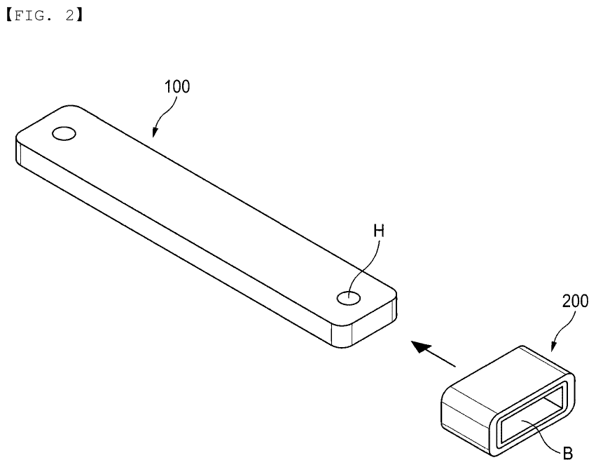

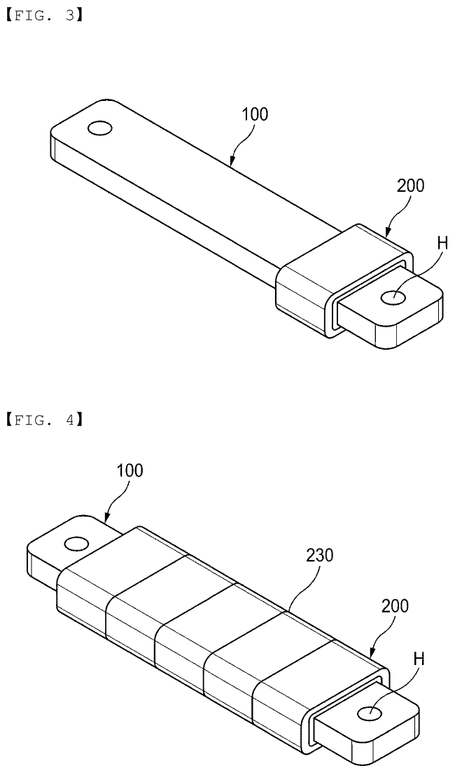

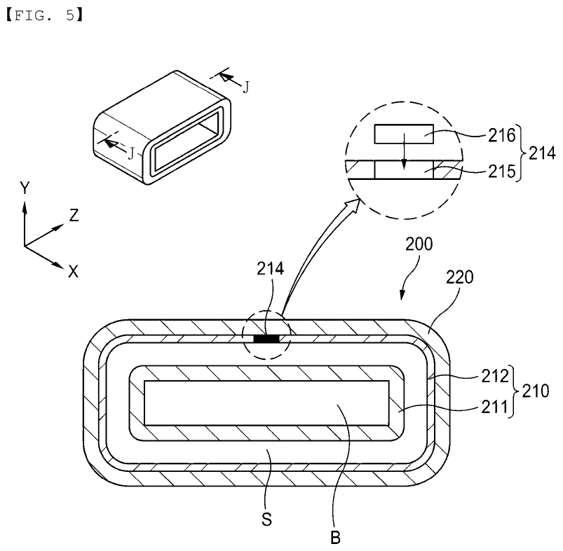

FIG. 2 is an exploded perspective view of an inter-module busbar according to a first preferred embodiment of the present invention, FIG. 3 is a view showing an example of assembly of the exploded perspective view of FIG. 2, and FIG. 4 is a perspective view of the inter-module busbar according to the first preferred embodiment of the present invention.

Referring to FIGS. 2 to 4, the inter-module busbar according to the present invention includes a metal bar 100 having fastening holes H formed in opposite ends in order to connect battery modules to each other, the metal bar being made of an electrically conductive metal material, and an insulator 200 fitted and located on a part of the metal bar 100 excluding the opposite ends thereof.

One end of the metal bar 100, which is one of opposite ends of the metal bar, may be connected to a (+) terminal of one battery module, and the other end of the metal bar may be connected to a (−) terminal of another battery module. For example, each of the terminals of the battery modules may be configured in a bolt form such that the terminals are inserted into holes H provided in opposite ends of the metal bar 100 and are then tightened with nuts, whereby connection parts are securely fixed.

In addition, the thickness and the width of the metal bar may be set based on the magnitude of current that flows through the metal bar, and the metal bar may be variously manufactured depending on the installation location or installation conditions.

Meanwhile, the insulator 200 is configured in a structure that encloses the outside of the metal bar 100, and serves to protect the metal bar 100 while maintaining electrical insulation.

Referring to FIGS. 2 and 3, the insulator 200 is provided with a metal bar 100 insertion space B, and is fitted onto the metal bar 100 in a longitudinal direction thereof. The insulator 200 is configured in the form of a unit block for easy fitting onto the metal bar 100, which has an advantage in that the number of insulators 200 to be fitted onto the metal bar 100 may be flexibly adjusted depending on the length of the metal bar.

FIG. 4 shows an example in which a plurality of insulators 200 is fitted on the metal bar 100 over the entire length thereof.

The metal bar 100 may have various sizes and lengths, and each time the busbar needs to be newly designed and manufactured. However, the insulator 200 of the present invention may be further fitted onto the metal bar 100 within the length thereof, and the shape and the size of the metal bar insertion space B of the insulator 200 may be changed, whereby it is possible to effectively manufacture busbars of various sizes.

As shown in FIG. 4, the fitted insulators 200 may be fixed to each other in tight contact with each other via an adhesive 230 in areas adjacent to each other, whereby it is possible to prevent movement or deformation of the insulators.

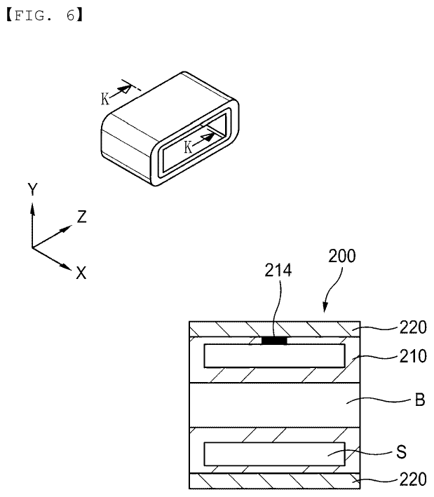

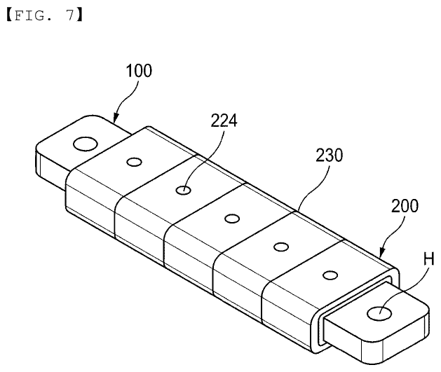

Hereinafter, the internal structure of the insulator 200 will be described in detail with reference to FIGS. 5 and 6.

FIG. 5 is a vertical sectional view of an insulator 200 according to a first preferred embodiment of the present invention, taken along line J-J, and FIG. 6 is a vertical sectional view of the insulator 200, taken along line K-K.

Referring to FIGS. 5 and 6, the insulator 200 includes a metal bar 100 insertion hole B, an inner insulation portion 210 configured to surround the metal bar, and an outer insulation portion 220 configured to surround the inner insulation portion 210.

The inner insulation portion 210 is configured in a donut-shaped structure, and includes a first insulation layer 211, which is an inner surface configured to enclose the metal bar insertion space B, an extinguishing liquid injection space S formed so as to surround the metal bar, and a second insulation layer 212, which is an outer surface.

In addition, the first insulation layer 211 and the second insulation layer 212 appear to be separated from each other in FIG. 5, but are substantially integrated into one, as shown in FIG. 6.

Here, the first insulation layer 211 and the second insulation layer 212 may be formed so as to have the same thickness, but the second insulation layer 212 may be formed so as to be thinner than the first insulation layer 211 in order to keep the metal bar insertion space B stable and to facilitate leakage of an extinguishing liquid to the outside when flames are generated, which will be described later.

The second insulation layer 212 has a first injection portion 214 including a first injection hole 215 configured to allow the extinguishing liquid to be injected therethrough and a first sealing cap 216 configured to seal the first injection hole 215, and the extinguishing liquid 213 may be injected through the first injection hole 215. After the extinguishing liquid is injected, the first injection hole is sealed by the first sealing cap 216, whereby leakage of the extinguishing liquid to the outside is prevented.

Here, the size and the shape of the first injection hole are not particularly limited and may be adjusted in consideration of injection efficiency of the extinguishing liquid. For example, the shape of the first injection hole may be polygonal, such as circular, oval, triangular, or quadrangular, or amorphous.

Meanwhile, it is obvious that each of the first insulation layer 211 and the second insulation layer 212 constituting the inner insulation portion 210 must be made of a material capable of storing the extinguishing liquid for a long time. Preferably, there are no particular restrictions as long as an expandable flame retardant silicone material that exhibits chemical resistance and that expands and melts such that the extinguishing liquid is easily exposed to the outside when the temperature thereof increases to a certain level or higher by flames is used.

The outer insulation portion 220 is configured in a structure that encloses the outer surface of the inner insulation portion 210, and is formed so as to surround the outer surface of the inner insulation portion 210 excluding opposite side surfaces thereof, as shown in FIGS. 5 and 6, in the first embodiment of the present invention.

In addition, the material for the outer insulation portion 220 is not particularly restricted as long as refractory silicone, which is ceramized (converted to a ceramic material) when exposed to flames, whereby small cracks are formed, is preferably used.

As an example, ceramized refractory silicone exhibits the performance of a general silicone resin at room temperature, but at high temperatures, the structure of refractory silicone is changed to a ceramized structure, whereby refractory silicone has ceramic properties, and therefore ceramized refractory silicone may withstand impact while maintaining certain strength.

Change in shape of the insulator 200 due to flames will be described later in detail with reference to FIG. 11.

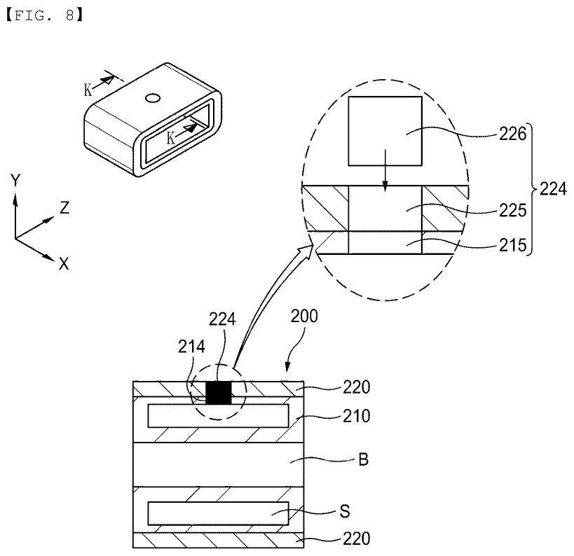

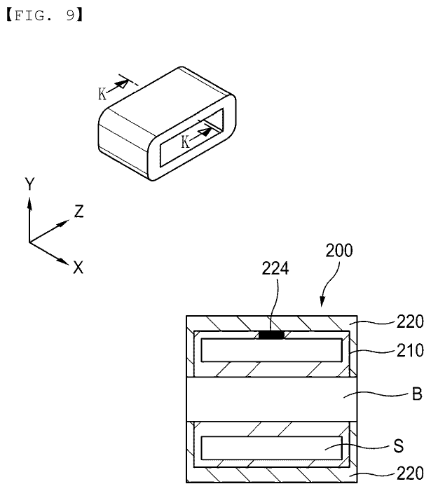

FIG. 7 is a perspective view of an inter-module busbar according to a second preferred embodiment of the present invention, and FIG. 8 is a vertical sectional view of an insulator 200 according to a second preferred embodiment of the present invention, taken along line K-K.

Since, in the first embodiment described above, the extinguishing liquid is injected into the inner insulation portion 210, sealing is performed by the first sealing cap, and the outer insulation portion 220 is provided, no additional extinguishing liquid can be injected, as shown in FIG. 4.

In contrast, as shown in FIGS. 7 and 8, the inter-module busbar according to the second embodiment of the present invention includes a second injection portion 224 configured such that a first injection hole 215 provided in an inner insulation portion and a second injection hole 225 provided in an outer insulation portion 220 communicate with each other in order to inject an extinguishing liquid and such that the first injection hole 215 and the second injection hole 225 are sealed by a second sealing cap 226.

Particularly, in the second embodiment, the inner insulation portion 210 and the outer insulation portion 220 may be manufactured without the provision of an extinguishing liquid injection space, and then the second injection portion 224 may be formed through a subsequent process, whereby a work process may be relatively simplified, compared to the first embodiment. Furthermore, it is possible to manufacture the insulator 200 without injecting the extinguishing liquid and to selectively inject the extinguishing liquid through the second injection portion 224 depending on future use.

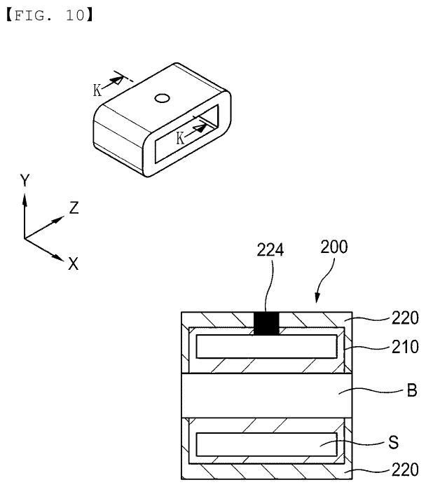

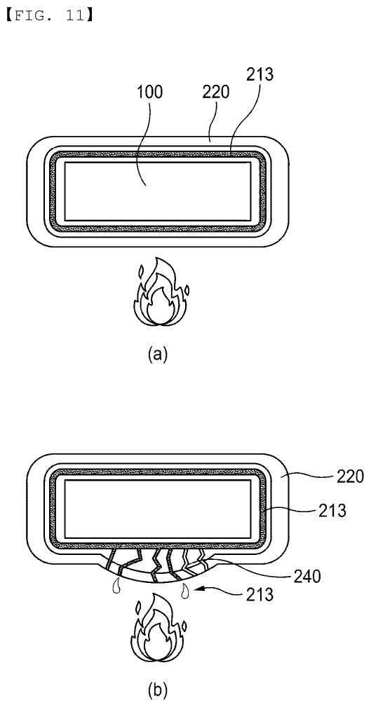

FIG. 9 is a vertical sectional view of an insulator 200 according to a third preferred embodiment of the present invention, taken along line K-K, and FIG. 10 is a vertical sectional view of an insulator 200 according to a fourth preferred embodiment of the present invention, taken along line K-K.

As shown in FIGS. 9 and 10, the insulator 200 is configured in a structure in which an outer insulation portion 220 encloses the entirety of an outer surface of an inner insulation portion 210, including a side surface thereof (but excluding an inner surface of a metal bar insertion space B).

The third embodiment of FIG. 9 is a modification of the first embodiment, in which the first injection portion 214 is provided at only the inner insulation portion 210, and the fourth embodiment of FIG. 10 is a modification of the second embodiment, in which the second injection portion 224 is provided.

Particularly, in the first and second embodiments, when the busbar is configured using only one insulator 200, the side surface of the inner insulation portion 210 may be directly exposed to flames, or even when a gap is formed between adjacent insulators 200 connected to each other via the adhesive 230, the insulators may be exposed to flames, which is prevented in the third and fourth embodiments.

FIG. 11 is a sectional view showing deformation of an inter-module busbar according to a preferred embodiment of the present invention due to fire under the inter-module busbar.

In general, when fire breaks out in a battery pack, a lot of heat and flames may be generated, whereby an insulation portion provided at an inter-module busbar may be burned away, and therefore electrical short circuit to a peripheral portion may occur. In particular, electrical short circuit may form an electrical closed circuit in the battery pack, whereby thermal runaway may be accelerated in the pack.

As shown in FIG. 11, (a) of FIG. 11 shows the shape of the inter-module busbar, which connects battery modules to each other, before deformation when flames are generated under the busbar, and (b) of FIG. 11 shows the deformed shape of the busbar after a certain period of time has elapsed since the flames occurred.

Referring to (b) of FIG. 11, when the flames are generated and the temperature increases to a certain temperature or higher, the surface of the outer insulation portion 220, which forms the outside of the insulator 200, is ceramized. At the same time, the inner insulation portion 210 applies pressure to the ceramized outer insulation portion 220 which expanding due to heating, whereby cracks 240 are formed in a lower surface of the outer insulation portion 220.

The inner insulation portion 210, which receives heat through the cracks 240, may melt, and the extinguishing liquid 213 therein may flow out through the cracks in the outer insulation portion 220, whereby it is possible to early extinguish the flames.

In general, fire extinguishment is divided into physical extinguishment (removal or blockage of oxygen sources, ignition energy, combustibles, etc.) and chemical extinguishment, which inhibits chain reaction of combustion through chemical control. Since the object of the present invention is to extinguish fire in a sealed battery pack, the extinguishing liquid 213 in the present invention preferably exhibits the property of insulation, and a halogenated compound extinguishing liquid, which corresponds to chemical extinguishment using a negative catalyst effect to extinguish fire by inhibiting chain reaction caused by the fire, may be used.

However, various busbars may be used depending on the use, and in addition there are various causes of fire, and therefore the type of the extinguishing liquid 213 is not limited, since the extinguishing liquid 213 may be readily employed by those skilled in the art.

Hereinafter, a process of manufacturing the inter-module busbar according to the t first embodiment of the present invention will be described.

First, a method of manufacturing an insulator 200 includes a first step of manufacturing an inner insulation portion 210 including a first insulation layer 211, a second insulation layer 212, and a first injection hole 215 using a method such as injection, a second step of injecting an extinguishing liquid 213 through the first injection hole 215, a third step of performing sealing using first sealing cap 216 to prevent leakage of the extinguishing liquid 213 when injection of the extinguishing liquid 213 is completed, and a fourth step of forming an outer insulation portion 220 configured to enclose the inner insulation portion 210.

In addition, the method further includes a fifth step of fitting a plurality of insulators 200 thus manufactured onto a metal bar 100 so as to cover the length of the metal bar excluding opposite ends thereof and fixing the insulators to each other using an adhesive 230 to manufacture an inter-module busbar.

Meanwhile, a process of manufacturing the inter-module busbar according to the second embodiment of the present invention is carried out by performing the fourth step of forming the outer insulation portion 220 immediately after the first step in the first embodiment and a step of injecting the extinguishing liquid 213 through the second injection portion 224 and performing sealing. In addition, the inter-module busbar may be manufactured through the fifth step described above.

The present invention has been described above with reference to specific embodiments. However, those skilled in the art to which the present invention pertains will appreciate that various applications and modifications are possible within the category of the present invention based on the above description.

### Description of Reference Symbols

10, 100: Metal bars
20: Insulative tube
30A: Bandage member
200: Insulator
210: Inner insulation portion
211: First insulation layer
212: Second insulation layer
213: Extinguishing liquid
214: First injection portion
215: First injection hole
216: First sealing cap
220: Outer insulation portion
224: Second injection portion
225: Second injection hole
226: Second sealing cap
230: Adhesive
240: Crack
H: Bolt fastening hole
S: Extinguishing liquid injection space
B: Metal bar insertion space

1. An inter-module busbar comprising:
a metal bar made of an electrically conductive metal material; and
at least one insulator located on a part of the metal bar excluding opposite ends of the metal bar,
wherein an extinguishing liquid is included in the at least one insulator.

2. The inter-module busbar according to claim 1, wherein the at least one insulator is provided with a metal bar insertion hole, and
wherein the at least one insulator is fitted onto the metal bar in a longitudinal direction of the metal bar.

3. The inter-module busbar according to claim 2, wherein the at least one insulator is a plurality of insulators fitted on the metal bar and fixed to each other by an adhesive.

4. The inter-module busbar according to claim 1, wherein the at least one insulator comprises:
an inner insulation portion configured to surround the metal bar; and
an outer insulation portion configured to enclose an outer surface of the inner insulation portion excluding a side surface of the inner insulation portion, and
wherein the inner insulation portion is provided with a space having the extinguishing liquid.

5. The inter-module busbar according to claim 4, wherein the space is formed between a first insulation layer in contact with the metal bar and a second insulation layer in contact with the outer insulation portion.

6. The inter-module busbar according to claim 5, wherein the space surrounds an entirety of the metal bar.

7. The inter-module busbar according to claim 5, wherein the inner insulation portion further comprises:
a first injection hole configured to allow the extinguishing liquid to be injected therethrough; and
a sealing cap configured to seal the first injection hole.

8. The inter-module busbar according to claim 5, wherein the inner insulation portion is provided with a first injection hole configured to allow the extinguishing liquid to be injected therethrough,
wherein the outer insulation portion further comprises a second injection hole configured to communicate with the first injection hole, and
wherein the inter-module busbar further comprises a sealing cap configured to seal the first injection hole and the second injection hole.

9. The inter-module busbar according to claim 5, wherein the first insulation layer is thicker than the second insulation layer.

10. The inter-module busbar according to claim 4 claim 1, wherein the at least one insulator comprises:
an inner insulation portion configured to surround the metal bar; and
an outer insulation portion configured to enclose an outer surface of the inner insulation portion including the side surface of the inner insulation portion, and
wherein the inner insulation portion is provided with a space having the extinguishing liquid.

11. The inter-module busbar according to claim 4, wherein the inner insulation portion is made of an expandable heat-resistant silicone material.

12. The inter-module busbar according to claim 4, wherein the outer insulation portion is made of a heat-resistant silicone material configured to be ceramized by heat.

13. The inter-module busbar according to claim 1, wherein the extinguishing liquid is an insulative material.

14. A battery pack comprising the inter-module busbar according to claim 1.
